(19) United States
(12) Patent Application Publication
(10) Pub. No.: US 2010/0167787 A1
(43) Pub. Date: Jul. 1, 2010

(54) Mobile phone system and method

(76) Inventor: Itamar Shmuel Weisbrod, Jerusalem (IL)

Correspondence Address: ROBERT G. LEV, 4766 MICHIGAN BLVD., YOUNGSTOWN, OH, 44505, US

(21) Appl. No.: 12/308,273

(22) PCT Filed: Jun. 12, 2007
(86) PCT No.: PCT/IL2007/000708

§ 371 Date: Dec. 10, 2008

Related U.S. Application Data
(60) Provisional application No. 60/812,616, filed on Jun. 12, 2006.

(51) Int. Cl. H04B 1/38; H04W 88/02

(52) U.S. Cl. 455/566; 455/574

(57) ABSTRACT

A method of displaying a select image on an Internet enabled mobile comprising a power supply, a memory, a processor and a screen preconfigured by a supplier of the mobile device to assume a dormant mode having a basic display that draws minimal power from the battery, with at most a basic display in a small part of the screen; the method comprising the steps of: (i) reprogramming the mobile device to display an image instead of the basic display while mobile device is otherwise dormant, by overriding the dormant screen mode, (ii) downloading a select image to a memory of the mobile device from an Internet source; (iii) displaying the select image on the screen instead of the basic display of the minimal power dormant mode, wherein the basic display is replaced by an enhanced display requiring more power than the basic display of the dormant mode.

### FIELD OF THE INVENTION

The present invention is directed to providing a method of advertising on a mobile phone.

### BACKGROUND

Mobile phones are widely available and fast becoming the preferred means of telecommunication. Increasingly, mobile phones are Internet enabled and the distinction between personal organizers and mobile phones is increasingly blurred.

Unlike most conventional wired phones that are used for audible communication only, mobile phones typically include one or more screens for displaying a range of visual information. Such visual information routinely includes the phone number of incoming callers or their identity if the calling number is listed in a contact list stored within the phone. The length of the call is also often displayed, as is the battery state. Sometimes the time and date are displayed. Occasionally the identity of the mobile network is displayed and sometimes the manufacturer and/or model name/number of the mobile device is shown, as may be the name of the customer billing package offered by the service provider. Indeed, the screen is, in many ways, a multipurpose graphical user interface.

The screen(s) can be used to display saved information such as telephone lists for example. Many mobile phones support games and short text messaging (SMS), and the screen(s) are also used for displaying these. Sometimes the screen displays images captured by a digital camera incorporated within the mobile phone or images sent as SMS attachments or e-mails to the phone. These may be photographic images, short video sequences, or animations. For Internet enabled phones, the screens can display a range of information, enabling Internet surfing.

In recent years, the resolution of mobile phone screens has increased tremendously. Whereas a few years back the mobile phone featured a one or two row array of 8 bar digital display blocks or a relatively small monochrome LCD, the modern mobile phone screens are backlit full color TFT type screens which are typically much larger.

These large actively illuminated color screens require more power than their predecessors and make significant demands on the mobile phone battery. Despite significant improvements in the battery life of rechargeable batteries over recent years, to conserve energy the mobile phone screen typically assumes a passive state when not in active use. In the passive state, the screen is darkened and minimal demands on the battery are made thereby conserving battery power for more useful purposes.

In clamshell and flip-style type phones, the main color screen is folded away together with the keypad, but often a second, typically smaller and sometimes monochrome external screen is displayed. This serves to provide minimum information to the user, showing that the phone is still on and that the battery has not run out. Often the state of the battery is shown and in many mobile phones, the time is displayed, so the mobile phone device additionally functions as a pocket watch.

In other types of mobile phones, the main screen may include a simple monochrome LCD state where such minimal useful information as the battery condition, quality of reception, missed calls not yet reviewed voice mail/SMS messages and the time and sometimes date are displayed.

Now the screens of state-of-the-art mobile phones are designed to assume a number of states. With reference to FIG. 1, a typical mobile device 10 is shown; in this case, a Symbian personal organizer phone device is shown by way of example only. When in active use, either because of the user recently interacting with one of the keys 12 in the keypad 14, or by using the mobile device 10 to communicate with a second party, or perhaps simply by picking up the mobile device 10 and thereby activating a motion sensor, the screen runs in, an active state wherein information is displayed—in this case selectable features such as Menu 16, length of conversation or Internet surfing period on a timer function, or actual time 20 on a clock, and the like. The screen 16 is actively backlit.

With reference to FIG. 2, when the interaction is terminated, the screen 16 typically assumes a standby mode wherein the time 22 and perhaps date 24 are shown in an active region 26 of the screen 16, but large regions 28 of the screen 16 are powered down, remaining blank. With reference to FIG. 3, sometimes one or more advertisements 30 are displayed on the large regions 28 of the screen 16, and sometimes a coupon 32 is shown, offering a discount or other benefit. As shown in FIG. 4, a logo or other image may be displayed on a peripheral part 28 of the screen 16.

Usage of the mobile device 10 requires conserving battery power, and after a short time period, typically 15-20 seconds, most or all of the screen 16 is powered down, going black (FIG. 5) or silver gray, depending on the technology used in the construction of the screen 16.

The exact sequence of events and the time periods for each stage of the power down to the screen vary widely from mobile phone device to mobile device. Sometimes, in the standby modes, a dynamic or static image, known erroneously for historic reasons as a screen saver, is displayed for a minute of so. One or more of such images may be supplied by the manufacturer, or may, at least in some mobile phone models, be selected and downloaded by the end user. Then, if no interaction occurs, the screen either shuts off completely, or displays just a clock or similar limited information.

The advertising potential of the screen of mobile phones not in active use has been recognized.

For example, Korean patent application number KR4088431 titled “Show-in technology, concerned with enabling a customer to receive the free background screen” provides a show-in technology designed to enable an advertiser to inform a customer that the customer can receive a free cellular phone background screen while a communication provider forms an advertisement under contract with the advertiser. Pictures, photos or moving images are downloaded from the Internet. The downloaded background screen has a coupon function as a cellular phone background screen advertisement. It appears that the screen downloaded is a background screen, displayed behind the details relating to the calls, and corresponds to the so called desktop or wallpaper of graphical operating systems for portable computers such as Microsoft® Windows® and the like. The images downloaded are clearly designed to be displayed when the user actively interacts with the mobile phone.

Korean patent application number KR1093612 titled “Advertisement service system through initial screen of cellular phone” relates to an advertisement service system through an initial screen of a cellular phone provided to optimize the effect of an advertisement by storing a transmitted advertisement and outputting the advertisement on a liquid crystal screen of a cellular phone when analyzing information through a protocol previously defined on the Internet with a wireless communication company and retransmitting an advertisement message to the wireless communication company during a power-on operation or a standby state after selecting a WAP(Wireless Application Protocol) service.

Essentially, a sponsor information management unit manages subscribing information of a sponsor. A sponsor authentication unit authenticates the sponsor in case that the sponsor works in an Internet home page on the Internet. A message storing unit stores a message inputted by the sponsor normally confirmed as a result of the authentication through the sponsor authentication unit. A data request receiving unit receives an indication signal so that a wireless communication company transmits an advertisement to an advertisement service system in case of operating the power-on, opening a flip, or a standby state after selecting a WAP service. A member confirming unit checks whether a user is a member before transmitting an advertisement message. A data editing unit edits the advertisement message to be suitable for a protocol and format discussed with the wireless communication company. A transmitting unit transmits the advertisement message edited through the data editing unit. A settlement processing unit processes a settlement with the sponsor corresponding to the advertisement transmitted through the transmitting unit. A charge conversion processing unit accumulates and manages information of a wireless communication subscriber and converts a subscriber point into an amount of money.

The above patent application is thus concerned primarily with producing advertisements for downloading to the mobile phone for display on the screen thereof when the flip covering the keypad is opened or when the user otherwise activates the phone, bringing it out of the energy saving passive state.

United Kingdom Patent Number GB2373681 titled “Mobile telephone device with idle screen” describes a system wherein the idle screen of a mobile telephone device is used to show updated information obtained from a remote information source (e.g. internet) and defined by a user of the device to be of a kind that is of interest to the user. Placing information of interest to the user, on all or part of the idle screen, makes the information instantly accessible without the user having to navigate to the required function (e.g. using a micro-browser) and select it. The information may be from a source selected by the user and may, for example, relate to financial, sport, news, traffic, weather, downloaded music or multi-player games information. Additionally, advertising and/or sponsor messages may be sent and displayed together or alternating with the information. The user may be able to select the schedule of updated information and use information sources with different priority settings. Alerts may be displayed in addition to or alternating with the updated information and the information may be provided via Smart Message type objects or WAP-push/pull. The displayed information may contain hyperlinks and may be location specific, for example, timetable, exhibit or password access information obtained via Bluetooth.

It will be noted that the idle screen is used and not the dormant screen. In other words, a detailed display is shown to the user not long after a call or other interaction has been terminated or prior to commencement of an interaction, presumably by opening a flip or by a vibration sensor detecting that the phone has been picked up.

Japanese Published patent application number JP2005300806 titled “Advertisement System Utilizing Cellular Phone Corresponding To Internet” relates to an advertisement system for an Internet capable mobile phone which displays a frame arranged on screen for showing display advertisement data when the power supply switch of the mobile phone is turned on, thereby effectively utilizing an Internet enabled cellular phone as an advertisement medium. In the specific solution described, a computer built into the cellular phone functions as a means for detecting that a power supply switch is on, a data storage means for storing advertisement display data linked to a prescribed site on the Internet in a memory in a format of an icon, characters, or the like, a frame setting means for setting a frame in a prescribed area on the screen of the cellular phone, and a display means for displaying a frame on the screen of the cellular phone and displaying the advertisement display data in the frame 20 when the power supply switch is turned on. When the power supply switch of the cellular phone corresponding to the Internet is turned on, an advertisement display linked to a prescribed Internet site is automatically displayed on an initial picture in the format of an icon, characters, or the like and a required amount is returned to a user of the cellular phone in accordance with the number of accesses to the site. It is noted therefore that as with the previously described publications, the advertisement is once again displayed in response to an interaction with the phone, as a transient display on the screen as the phone powers up.

Usage of advertising on mobile phones as a method of defraying at least part of the phone bill is known. For example Korean patent application number KR2004017 describes a “Method for reducing charge for portable mobile communication terminal through internet advertisement” in which a method for reducing charge for a portable mobile communication terminal through an Internet advertisement is provided to enable a user to reduce charges for a portable communication terminal by enabling the user to display a window for an advertisement to a screen of a computer without the need for reaching a specific amount of money accumulated, and by reducing the charges as much as the amount of money accumulated at a payment day. Essentially a user who became a member inputs a portable communication terminal number to a computer. The user clicks an advertisement or displays a window for the advertisement to a screen of the computer. Where earnings of the advertisement is generated, a relevant Internet advertisement service company stores an amount of money accumulated to the number inputted from the user. The user fits a payment day of the portable communication terminal service company. Member users are classified into portable communication terminal service companies. An amount of money accumulated by the users relevant to the portable communication terminal number is summed up. After that, the amount of money accumulated is paid to the portable communication terminal service company. The user reduces charges as much as the amount of money accumulated.

It will be noted that in order to track the effectiveness of the advertising, the user has to interact with the advert. This necessitates its display when the user near to or during the user's active interaction with the phone, i.e. before, during or after a call or other interaction. It is pointless to display such an advertisement when the user is not interacting, and the resultant battery drain will, no doubt deter users from becoming a member. Furthermore, the power drain that would result from keeping the phone in an active state with the screen thereof backlit for example, even when no interaction is expected, would actually decrease the likelihood of an interaction since the mobile phone would invariably be switched off due to the battery running out.

In some systems, an additional screen is provided specifically for advertising purposes. For example, Korean patent application number KR1083787 relates to a three-picture wireless terminal display method having a window for the exclusive use of advertisement. The three-picture wireless terminal display method relates to a window for the exclusive use of an advertisement that is provided to maximize the efficiency of advertisement and to reduce a rate of a user due to advertisement profit by performing more effective mobile advertisement. In a wireless Internet terminal using three display screens, a mobile window for the exclusive use of an advertisement is installed to display the advertisement in a banner form or in a moving picture for a given period when a user uses wireless Internet. The mobile window is also used as an image screen in the case of a visual telephone call, thereby enabling the visual telephone call without opening a folder. It will be appreciated that the system displays advertisements only when the user interacts with the mobile phone and the additional window increases the cost and complexity of the unit.

In Korean patent application number KR1044209 titled “Advertisement reproducible mobile phone and advertising method using the same”, an advertisement reproducible mobile phone and a corresponding advertising method are provided for the advertiser to enable a target advertisement marketing according to user information and for a user to remove a boredom during a response standby time period and benefit a substantial communication charge reduction by receiving a compensation cost for viewing an advertisement. The mobile phone has a function of storing and reproducing an advertisement data of MPEG4 or JPEG/GIF format (i.e., a mobile advertisement or a banner advertisement, etc.), so that it is connected to an advertisement provider server to download advertisement data and to store the data in a memory late at night or during a voice call response standby time period. When a user requests a voice call (he or she depresses a call button) or requests information of a radio Internet, the advertisement data stored in the memory is displayed on an LCD screen. And then the advertisement of the LCD screen disappears instantly when the called party answers the phone or when it is switched to a voice mail box in the case of the voice call, or when the request information is completely received in the case of a radio Internet call, so that the user can recognize the call connection (the voice or the Internet call). The advertisement is displayed for only a quite limited period, albeit in a downtime when the phone owner is interacting with the phone.

Japanese Patent Application Number JP 2006079203 relates to an advertisement distribution system for delivering an advertisement to e.g. a mobile phone, which displays a default window at portable terminal, in stand-by time during download of advertisement information.

The application is designed to facilitate introducing a function to display advertisement information on a mobile communication terminal and also quickly respond to allow a correction of a bug and an addition of a new function to the terminal in a standby time period during information acquisition or by using a standby screen. Essentially, a mobile communication terminal having a function to connect with a first network (the Internet) and a function to download advertisement data from an advertisement providing server is provided with the software having a browser function as an application (application software for advertisement information display). The system counts the number of times or the time period in which the advertisement information is displayed by an element for browser advertisement display or an element for standby advertisement display of the application software in the standby time period during the information acquisition or by using the standby screen. Thus once again the mobile phone is used in standby mode only.

U.S. Patent Application Number US20050138105 titled “Method for playing interactive contents for standby mode in a mobile communication terminal, and a mobile communication terminal using the same” describes an interactive content playing method for a mobile communication terminal, that involves playing and displaying a play region corresponding to a manipulation key input defined by interactive contents action information. The method described relates to playing interactive contents for standby mode in a mobile communication terminal, which allows a user of the mobile communication terminal to perform a variety of operations on a standby mode by operating a player to play interactive contents provided by mobile communication terminal makers or communication service providers on the standby mode in a user-specified standby screen and allows a direct Internet browsing to a specific URL based on a user's operation, and a mobile communication terminal using the same. According to the method for playing interactive contents for standby mode in the mobile communication terminal and the mobile communication terminal, using the same, the interactive contents can be played in the standby mode and so other pictures can be viewed in the standby mode according to a key operation by a user. Further, when a user presses a particular key while the user views an advertisement moving picture played in the standby screen mode of the mobile communication terminal, it is possible to immediately access a URL site included in the advertisement moving picture, which contributes to activation of advertisement industry using the mobile communication terminal. Furthermore, various kinds of interactive contents can be provided for the mobile communication terminal, and thus, the mobile communication terminal can be more effectively sold. In addition, the user can easily download the interactive contents for standby mode into the mobile communication terminal via a network. It will therefore be noted that the display of pictures is in a standby mode where the user has to physically interact with the phone.

Japanese Patent Application Number JP2005017741titled “Termination Melody Advertisement Agent and Distribution Agent System” provides a termination melody advertisement agent and distribution agent system capable of correcting unfairness due to the order of many distribution companies listed on the screen of a mobile telephone set and obtaining the same effect with retrieval of many distribution companies by one advertisement agent and distribution agent site as to a user side.

The termination melody advertisement agent and distribution agent system is constituted by interposing an advertisement agent and distribution agent site which contracts with a plurality of distribution companies each having many termination melodies to act for totally adverting and distributing termination melodies that those companies have in a termination melody distribution system constituted by interconnecting the plurality of termination melody distribution companies to a user who selects and uses a desired musical piece among the termination melodies by using a mobile telephone through the Internet.

The screen is restricted to displaying lists of termination melody suppliers and not advertising data per se. The user is required to actively select musical pieces. Thus the application does not relate to passive, visual advertising.

Korean Patent application number KR4077464 titled “Method for newspaper advertisement on liquid crystal screen of personal mobile telephone by using client service—the method induces user's interest in an advertisement” relates to a method for displaying a newspaper advertisement on the liquid crystal screen of a personal mobile telephone by using a client service. The method is provided to increase interest in an advertisement and to improve the image of a company while helping to make society better. A business proprietor receives messages, pictures, photographs of a client through an Internet homepage, a facsimile, and e-mails, limiting contents to make optimistic society or make a relationship better. The contents requested by the client are inserted in a newspaper together with an advertisement. If the newspaper is issued, a reader who is targeted by the client understands the intention of the client. Misunderstanding and trouble between the client and the target reader are resolved by the advertisement with the messages, pictures and/or photographs of the client. It appears that the recipient of the display on the mobile phone screen actively interacts with same.

Korean Patent Application Number KR4052677 titled “Method for processing ad image through sub device of mobile communication terminal” relates to a method for processing an AD (ADvertisement) image through a sub device of a mobile communication terminal that is provided to make a personal user meet a mobile communication market environment fast and to maximize an AD effect through an instant AD. When the user mounts a PDA (Personal Digital Assistant) in its cradle, an ID and a password embedded into the PDA are transferred to a server and a play frequency of a previously downloaded moving image AD is stored to the server. In the case that a new AD is updated, the new AD is synchronized with the PDA by being downloaded to the PDA. When the user makes/receives a call, the previously stored moving image AD is displayed on a part of a screen. When a short message of a specially defined form is received, the moving image AD is displayed on the part of the screen. In the case that an Internet information storing service program is played by user's request, the moving image AD is displayed on a part of a screen.

Here again, the advertisement is displayed whilst the user actively interacts with the mobile phone/personal organizer.

Japanese Patent Application Number JP2004246548 titled “Coupon display device” relates to a Mobile telephone having a coupon display function, and provides a method to easily manage a coupon displayed on a terminal device such as a cellular phone.

The cellular phone is capable of sending and receiving email using the Internet and of browsing Websites. The Websites of one or more stores are stored in a Web server and a variety of coupon data are shown on the Websites. The user of the cellular phone causes the coupon data downloaded from the Web server to be displayed on the screen of the cellular phone and presented to clerks in the store to enjoy a variety of services such as discount services. After displaying the image of the coupon according to conditions set in the coupon data, such as expiration date, the cellular phone deletes the coupon data a predetermined time thereafter. This enables not the Web server but the cellular phone 10 to manage the coupon. It will be appreciated that the coupon display in this system is managed actively by the user. It is not a passive image that is passively displayed.

Korean Patent Application Number KR3005596 titled “Method and system for supplying advertisement/information using wireless internet terminal” describes a method and system for supplying an advertisement or information that allows the integral management of an advertisement/information contents supplied by a mobile communication businessman or an MISP(Multi Internet Service Provider) company through a database by utilizing an “AD(advertisement)-ware” system developed by a wireless Internet information service provider.

A user starts a wireless Internet and connects to an MISP, and requests information to a service provider AD server by a tag inserted in an MISP contents page. It is judged whether target information such as a mobile phone number, a member ID, a terminal inherent number, an MISP code, an advertising position, etc. is entered or not. If target information is entered, it is judged whether an advertisement to be transmitted exists in a corresponding position. If target advertisement to be transmitted exists, the target advertisement is transmitted and a screen having an advertisement is displayed. It will be appreciated that the system is an active one, where the mobile phone user pulls information from service provider. It is not a system for displaying information on the screen of the mobile phone when the user does not specifically request such information.

Korean Patent Application Number KR2060374 titled “Advertisement display method in wireless mobile terminal using file downloading time” relates to an advertisement display method in a wireless mobile terminal using a file downloading time provided to reproduce and screen-output an advertisement message close to the time required for the downloading a high capacity file to a wireless mobile terminal. Here again, the advertisement is displayed at a time when the user expected to see it because an active interaction occurs.

Korean Patent Application Number KR2046386 titled “Method for displaying advertisement on display screen of mobile terminal” relates to yet another advertisement displaying method for a mobile phone that involves selecting advertising data to be displayed from a memory, after determining whether the phone is activated.

Essentially a method for displaying an advertisement on a display screen of a mobile terminal is provided to consecutively display the contents of an advertisement on the display screen of a user's mobile terminal, whilst the user is actively engaged in a telephone conversation or an Internet interworking operation.

Korean patent application number KR2030182 titled “Method for offering multimedia advertisement type coupon by using waiting screen on mobile terminal” describes a multimedia advertisement type coupon service method provided to enable a user to access a coupon service system via a mobile terminal if the user needs a coupon, to download a multimedia advertisement type discount coupon from the coupon service system, and to show the downloaded multimedia advertisement type discount coupon to a corresponding affiliated store. The method comprises steps of a user accessing a coupon service system via a mobile terminal or a PC over the Internet and inputting personal data with mobile terminal related data via a user registration module, the coupon service system approving the user personal data and the mobile terminal related data via a corresponding mobile communication company, allocating an ID and a password to the user if the user data and the mobile terminal related data is normally approved, the coupon service system offering coupon information such as a discount rate, a preview or geometrical positions of affiliated stores and enabling the user to select a discount coupon via a coupon selection and transmission module, if the user selects one discount coupon, the coupon selection and transmission module extracting the discount coupon from a database, the coupon selection and transmission module transmits the discount coupon to the mobile terminal via the corresponding mobile communication company, and a point management module calculating points whenever the user downloads the coupon, accumulating the points, and storing them at a database.

It will be appreciated therefore, that the method is an active method wherein the user pulls coupon via the mobile phone by actively interacting with same.

Korean Application Number KR2001987 titled “Advertisement system through internet phone service for mobile communication terminal and method thereof” describes an advertisement system through an Internet phone service for a mobile communication terminal and its method, provided to accomplish an advertisement effect by providing advertisement information instead of reducing a use expense or exempt the whole charge for a mobile communication terminal user by providing an Internet phone service for the mobile communication terminal located in a specific area when the mobile communication terminal moves into an Internet phone service area of an Internet phone service provider. The mobile communication terminal is in a standby state and receives certain advertisement information. In the standby state, the mobile communication terminal can be communicated with both a radio base station of a mobile communication provider and an Internet phone radio base station. The Internet phone radio base station transmits the advertisement information of the Internet phone service provider wirelessly so as to be displayed on a screen of the mobile communication terminal. It is checked whether the mobile communication terminal is in a transmission mode. When the mobile communication terminal is in a transmission mode, that is, when the mobile communication terminal transmits an Internet phone service request signal, a procedure for providing the Internet phone service is performed. The Internet phone radio base station allocates a required radio resource and sets a radio path with the mobile communication terminal. When the Internet phone service is initiated and the mobile communication terminal is connected to a called party through the Internet phone radio base station, the Internet phone service providing unit and Internet network, a call communication data is exchanged through the formed path. It is checked whether a call has been terminated. If the call has been terminated, the radio resource allocated by the Internet phone radio base station is restored and the Internet phone service is terminated. When the mobile communication terminal is moved out of the Internet phone service area, it can communicate only with the radio base station of the mobile communication provider.

It appears that though the downloading to the mobile terminal occurs when the mobile terminal is in a standby mode, the advertisement is displayed in an active state.

The prior art is thus replete with advertising related patents and patent applications for downloading and displaying advertisements and other images on the screen of a mobile phone. Some of these are characterized by active involvement, with the user being required to pull the advertisement to be displayed. Others are characterized by the advertisement being displayed when the phone is waiting for a connection or is just opened, i.e. in response to an interaction and using a standby screen.

In some systems, the advertising downloaded to a mobile phone is displayed at all times. For example, in Japanese Patent Application Number JP2002101059 titled, “Mobile Telephone Function Extension System Using Data Broadcasting, And Method Of Distributing Data” relates to a mobile telephone functionality extension system in which a user selected broadcast data with URLs is displayed which is used for accessing specific servers.

The technology enables the display of broadcast information by data broadcasting on a personal computer, and at the same time, data-broadcasting information sites over the Internet accessible for reading information. Essentially, a data-broadcasting station sends the data (advertisements, portal screens, programs, music, etc.), from a sponsor as data-broadcasting waves. A mobile telephone receives the data by an antenna of a data-broadcasting receiving unit, and only the data selected for the user is temporarily stored in the mobile telephone. When the mobile telephone is powered on, the selected data such as advertisements, portal screens, programs, and music, are displayed at all times on a displaying section. For more detailed information, the user of the mobile telephone can access servers over the Internet, using URLs which are included in the data. Such systems are intrusive, and may distract the user when user is actively interacting with the mobile phone. Furthermore, they are power hungry in that the selected data is displayed at all times.

### SUMMARY OF THE INVENTION

It is an aim of embodiments of the invention to provide an advertising method that displays an advertisement on the screen of a mobile phone over an extended time period.

It is a further aim of preferred embodiments of the invention, that the advertisement is displayed on the screen when the mobile phone is not being used, thus not interfering with user requirements of the screen.

In accordance with a first aspect, there is provided a method of displaying a select image on a mobile device comprising a power supply, a memory, a processor and a screen preconfigured by a supplier of the mobile device to assume a dormant mode in which the screen draws minimal power from the battery, with at most a basic visual display in only a section of the screen; the method comprising the steps of: (i) reprogramming the mobile device to display an enhanced display instead of the basic display by overriding the dormant screen mode; (ii) downloading a select image to a memory of the mobile device from an Internet source; (iii) displaying the enhanced display comprising the select image on the screen instead of the basic visual display of the minimal power dormant mode, wherein the displaying of the enhanced visual display requires more power than the minimal power required far the dormant mode.

Optionally, the step (i) of reprogramming comprises downloading a program to the mobile device from a website over the Internet using an appropriate protocol such as GPRS or UMTS, for example. Typically, the downloading of the program occurs when the mobile phone is dormant.

Alternatively, the step (i) of reprogramming comprises coupling the mobile device to a computer terminal and overwriting settings of the mobile device.

Alternatively again, the step (i) of reprogramming comprises exchanging a SIM card of the mobile device.

In one configuration, the select image is displayed intermittently whilst the mobile device is otherwise dormant.

In some embodiments, the step (i) of reprogramming to show a more than minimal power requiring image is over-rideable by the user to conserve power drawn from the power supply.

Typically, the power supply is selected from the list comprising: rechargeable batteries and single use batteries.

Optionally, step (ii) of downloading a select image occurs when the mobile phone is in a dormant state by a stealth technology.

In another configuration, the select image is displayed continuously whilst the mobile device is otherwise dormant.

Optionally, the select image is backlit by backlighting the screen despite the mobile device being otherwise dormant.

Typically, the select image includes a clock and a static image downloaded to the screen and displayed on a portion of the screen not where said clock is displayed.

Optionally, the image is multicolored.

Optionally, the image comprises a plurality of static images displayed sequentially.

Optionally, the image is an animation.

Optionally, the mobile device comprises a telephony terminal, the image comprises an advertisement and revenue provided to a telephone service provider by an image provider subsidizes billing of telephony service provider.

Optionally, the image comprises a coupon and said user can interact with said coupon thereby activating the mobile device and leaving the dormant state.

Typically an interaction with a key of the keypad will activate the mobile device and cause screen to show a display other than the more than minimal power drawing display of the invention.

Typically the mobile device is a mobile phone.

Alternatively the mobile device is selected from the list comprising a laptop computer, a palmtop computer, an MP 3 player, an MP 4 player, an iPOD, a tablet and a personal organizer.

In a second aspect the present invention is directed to providing a mobile device comprising a battery, a processor, a memory and a screen, the internet enabled mobile device having a dormant state for conserving power drawn from the battery such that when in the dormant state a basic visual display requiring minimal power is displayed on the screen, wherein said mobile device is reprogrammed to display features on the screen in the dormant state by drawing more power than the minimal power required by the basic visual display of the dormant state as programmed by the manufacturer.

In a third aspect the present invention is directed to providing a mobile device comprising a battery, a processor, a memory and a screen, the mobile device comprising a reprogrammed dormant state such that when dormant, the screen draws more power from the battery than the minimal power supplied to the screen for displaying the dormant display in the configuration supplied by the supplier.

In a fourth aspect a power hungry dormant state of a mobile phone is provided wherein a screen of the mobile phone displays an image.

Optionally the image is a multicolored image.

Optionally the image is a graphic image.

Optionally the image is a text image comprising letters.

Optionally the image is animated.

Optionally the image allows an interaction, wherein the interaction activates the mobile device, bringing it into an active state.

By mobile phone, any portable telecommunication device supporting full duplex cellular telecommunication is intended, including personal digital assistants, Palm top computers and the like.

By “dormant state” the lowest power configuration of the phone is intended, when the screen draws minimal power.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice. In the accompanying drawings:

FIG. 1 is a plan view of a mobile device having a keypad for interaction therewith, the screen thereof showing an active image as known.

FIG. 2 is a plan view of the mobile device of FIG. 1 showing a passive screen comprising a clock display on a portion of the screen thereof as known.

FIG. 3 is a plan view of a mobile device of FIG. 1 wherein part of the screen is used to display an advertisement and part of the screen is used to display a coupon as known.

FIG. 4 is a plan view of a mobile device having a keypad for interaction therewith, the screen thereof showing an image, as known.

FIG. 5 is a plan view of a mobile device in power saving dormant mode wherein the screen is black as known.

FIG. 6 is a schematic block diagram showing a mobile phone configured for downloading a program from the Internet;

FIG. 7 is a schematic illustration of a mobile phone 10′ showing a dormant state wherein the screen thereof draws more than minimal current;

FIG. 8 is a flowchart showing how a display that requires more than minimal power may be downloaded over the Internet for displaying on a screen of a mobile phone, instead of the dormant display wherein the screen is darkened or configured to show a clock;

FIG. 9 is a block diagram of the essential components of the macro system enabling a creator of content to send content via the Internet to be displayed on the dormant screen of a mobile device, and

FIG. 10 is a flowchart showing one method by which content may be sent from the creator to the mobile device where it is displayed on the dormant screen thereof.

### DESCRIPTION OF THE PREFERRED EMBODIMENTS

In the prior art, advertisements and other content have been delivered to mobile phones and displayed when the user interacts with the mobile phone, whilst waiting for a call to be connected, or when an interaction is anticipated, such as when motion sensors indicate that the mobile phone has been picked up, for example. In contradistinction to the prior art, in embodiments of the present invention, images are downloaded and displayed on the screen when the mobile phone is dormant, and not in standby mode, overriding the low power dormant mode setting of the mobile phone as supplied by the manufacturer.

The screen of the mobile phone thus serves as an advertising feature that preferably attracts the eye by virtue of attributes such as being brightly colored, illuminated, flashing or otherwise animated, and is not merely configured to be viewed when a user is expected to be interacting with the mobile phone. The exact attributes will vary from application to application, depending on the functionality of the mobile phone, advertiser's preferences and the like.

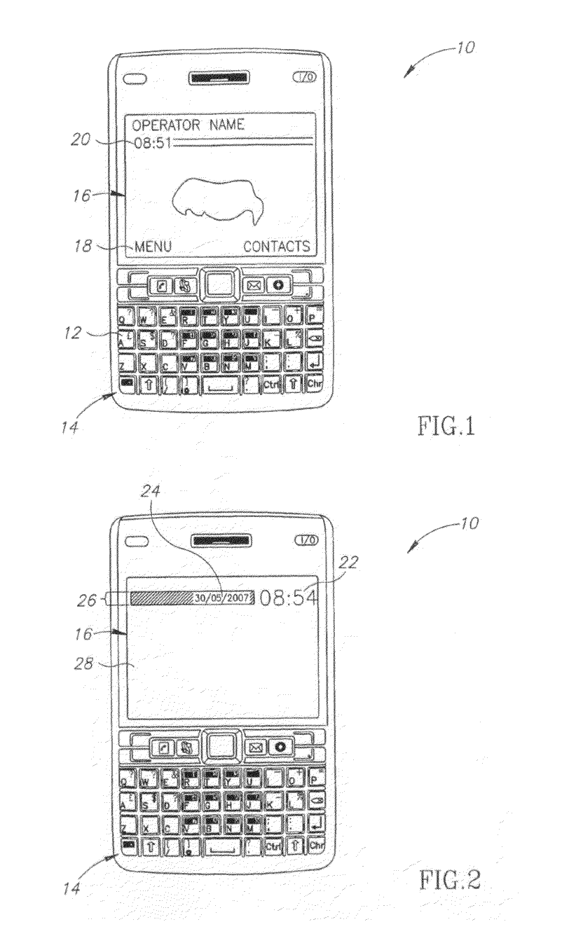

With reference to FIG. 1, a typical mobile device 10 of the art is shown; in this case, a Symbian personal organizer phone device is shown by way of example only. When in active use, either because of the user recently interacting with one of the keys 12 in the keypad 14, or by using the mobile device 10 to communicate with a second party, or perhaps simply by picking up the mobile device 10 and thereby activating a motion sensor, the screen thereof runs in an active state and shows an active image wherein information is displayed—in this case selectable features such as Menu 16, length of conversation or Internet surfing period on a timer function, or actual time 20 on a clock, and the like. The screen 16 of state-of-the-art devices is typically fully color and is actively backlit, thereby needing a lot of power.

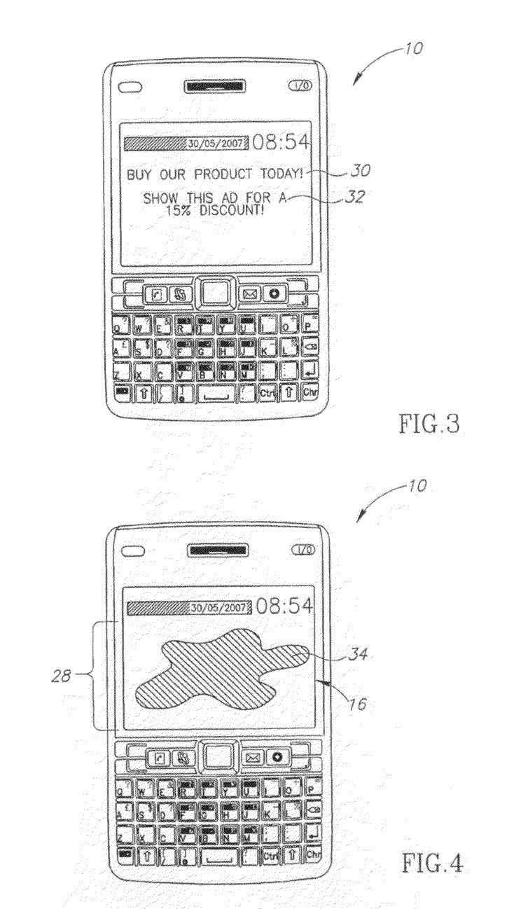

With reference to FIG. 2, when the interaction is terminated, the screen 16 of the mobile device 10 as typically configured, assumes a power saving, standby mode wherein the time 22 and perhaps date 24 are shown in an active region 26 of the screen 16, but large regions 28 of the screen 16, remain blank. With reference to FIG. 3, in the standby mode, sometimes, to take advantage of the fact the user has recently interacted with, or is expected to interact with the mobile device 10, textual messages, such as one or more advertisements 30 may displayed on the large regions 28 of the screen 16 not utilized in the configuration shown in FIG. 2, and sometimes a coupon 32 is shown, offering a discount or other benefit. As shown in FIG. 4, the peripheral regions 28 of the screen 16 may also be used for displaying a logo 34 or other image.

Usage of the mobile device 10 requires conserving battery power, and after a short time period since the last interaction, typically 15-20 seconds, if no interaction occurs, the screen either shuts off completely, or a basic display of just a clock or similar limited information, is shown. Most or all of the screen 16 is powered down, going black (FIG. 5) or silver gray, depending on the technology used in the construction of the screen 16. To conserve power, when not in active use, the mobile device 10, such as an Internet enabled mobile phone assumes a dormant state wherein the screen 22 requires minimum power, either no power at all, going black, or the minimal power to display a clock or the like in a small, activated region of the screen.

The exact sequence of events and the time periods for each stage of the power down to the screen 16 vary widely from mobile phone device to mobile device, and are set by the manufacturers taking into account the typical battery life of the battery used for powering the device, the targeted market and similar considerations. Sometimes a dynamic or static image, known erroneously for historic reasons as a screen saver, is displayed for a minute of so. One or more of such images may be supplied by the manufacturer, or may, at least in some mobile phone models, be selected and downloaded from the Internet by the user.

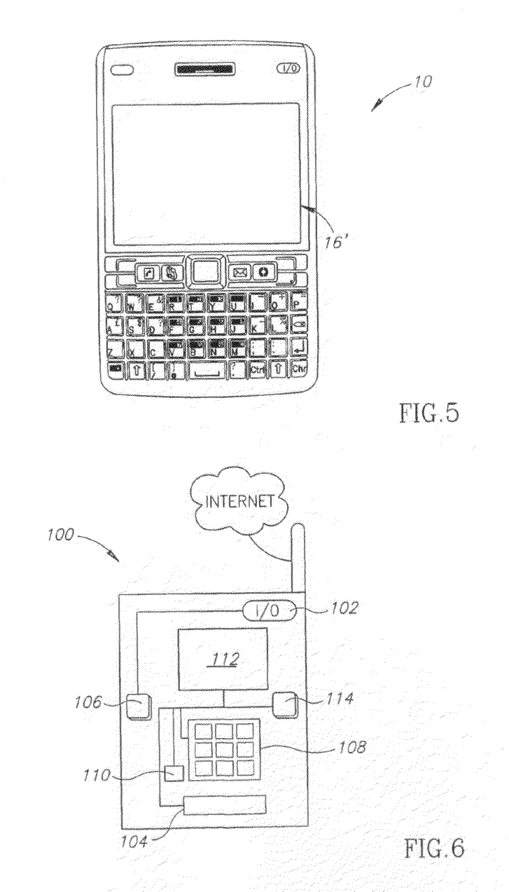

With reference now to FIG. 6 a partial functional block diagram of the essential elements of a prior art mobile phone 100 having Internet 102 enablement is schematically shown. The Internet enabled mobile phone 100 includes a battery 104, a processor 106, a keypad 108 a memory 110, a display screen 112 and optionally, a vibration sensor 114. Other elements are, of course included in mobile phones 100 and the like, but are superfluous to the embodiments of the present invention described hereinbelow, which embody a conceptual approach to using mobile devices, particularly mobile phones, for advertising overlong time periods, despite the resultant power drain.

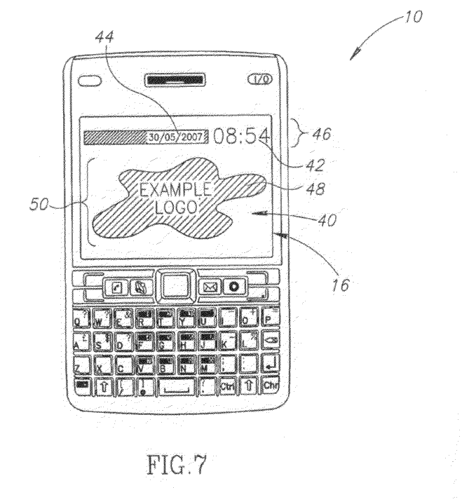

Thus in contrast with the minimal power blank screen 16′ that is shown on mobile device 10 in FIG. 5, which is a typical dormant, low power solution, with reference to FIG. 7, in an embodiment of the invention, the mobile phone 10 is reprogrammed to over-ride the dormant state, thereby showing a more interesting display 40 on screen 16, than the minimal display 16′ (FIG. 5) of the dormant state as supplied by manufacturer and programmed into the mobile device 10. More interesting display 40 may include the typical elements of the dormant display, such as a clock 42 and date 44 in a specific portion 46 of the screen 16, but it is a particular feature of preferred embodiments of the invention that an image or text, such as logo 48 is also displayed on the screen 16, particularly in peripheral regions of screen 50 away from the active bar 46 where the clock 42 is displayed.

The more interesting display 40 of the invention is shown on screen 16 when the mobile device 10 is not in use and not being disturbed, i.e. when lying dormant. The more interesting display 40 (FIG. 7) may be displayed constantly or intermittently. In contrast to the prior art however, the display 40 is not triggered by or otherwise related to the activities of the user. Rather, the dormant mode of the mobile device 10 is reprogrammed, or the mobile device is configured not to enter the power saving dormant mode of FIG. 5, but rather to require more power than the blank screen display (FIG. 5) or clock only display supplied by manufacturer/telephony network provider, and is intended for replacing or supplementing the dormant mode display of the mobile device as supplied, at selected times when the mobile phone is not in active use or in stand by state. It will be appreciated that other than the more interesting display 40 being shown on the screen 16, the mobile device 10 is essentially dormant. The more interesting display 40 draws more power than the dormant state shown in FIG. 5, and in addition to a clock, date and battery power indicator, the more interesting display 40 may be backlit, colored, include graphic elements and/or text, and may be animated or steady.

The dormant displays of mobile devices of the art, as supplied by manufacturer, often include a clock display. Once reprogrammed by a method of implementing the present invention, advertisements such as static images, graphics, text, coupons, animations, photo clips, digitalized photographs and the like are downloadable to the mobile phone 10 over the Internet connection 12 and are then displayable on a portion 50 of the screen 16 not where the clock 42 is, thereby utilizing a portion 40 of the screen 16 not utilized in the passive screens of the prior art, it being appreciated that in the dormant mode, most of the screen 16 is not utilized at all, and appears as the screen 16 appears when the battery 14 is dead/removed.

The more interesting image 40 downloaded to the mobile phone may include an advertisement. It may include a coupon, meaning that the mobile phone 10 user may be able to show the image 40 to a vendor to obtain a service, or may be able to interact with the mobile phone 10 showing the more interesting image 40, to obtain some service via the phone 10, typically by sending an SMS, an email or by establishing a telephone connection with a supplier.

The visual elements of the more than dormant screen images may be displayed continuously or intermittently whilst the phone 10 is otherwise dormant. However, it will be noted that the displaying of the image is in no way connected with interacting with the phone 10 or with a movement being detected by movement sensors 114 (FIG. 6) incorporated in many prior art mobile phones and the like.

Because, minimally, previously blank portions 40 of the screen 16 are utilized for display purposes, or screen 16 is backlit, the power drawn from the battery 104 by the mobile phone 10 when in the more than minimal power drawing mode of FIG. 7 showing more interesting display 40 is more than the power drawn in the dormant mode provided by manufacturer, this despite the phone 10 being otherwise dormant. This relatively high energy draining usage of the screen 16 in the more than minimal power drawing mode of FIG. 7 adversely affects battery 104 life. Nevertheless, since many mobile phones 10 are recharged whilst driving, and generally state-of-the-art mobile phones can last for three or four days without recharging and recharging is faster than ever before, this additional power drainage is acceptable for many users.

Although the mostly blank dormant screen 16′ (FIG. 5) is replaced by a static monochrome image in one embodiment of the invention, in preferred embodiments of the invention to make the image more eye-catching, the more interesting displayed image 40 may be multicolored. Instead of a single static image being displayed continuously, the image may be displayed only intermittently or occasionally merely flashed; it being appreciated that the very fact that the image is displayed on what was previously a substantially blank or darkened screen, itself draws the eye. In some embodiments, the display comprises a plurality of static images displayed sequentially instead of one image.

Although typically the displayed image is non-functional, and merely serves as an advertisement or the like, optionally, the display can serve as a coupon and provide value to the user. In some embodiments, the user can show the displayed coupon to a vendor and gain a discount. In other embodiments, on viewing the displayed coupon, the user may be able to interact with the mobile phone 10 by pressing the send button on keypad 14 to establish a telephone call, by sending an SMS or by accessing an Internet 12 website 13 through a link in the display 16, thereby leaving the dormant state.

The more interesting display 40 may include an animation or a video clip, thereby being a dynamic display rather than a static image. Where the image downloaded and displayed is an advert, revenue generated by the display provider (i.e. the advertiser), may be used to subsidize usage of the mobile phone 10, perhaps being offset against the bill ran up for phone calls made, for example.

In some embodiments, the user can deactivate the more than minimal power requiring display 40, so that the dormant display 16′ intended by the manufacturers (such as the clock or blank screen) can be used instead of the image(s) downloaded. This overruling of the reprogrammed passive state of the invention may be useful to conserve power, such as where the batteries 104 need recharging or where the user knows he/she will be unable to recharge the mobile phone 10 perhaps because of having traveled without the recharger, for example. Another scenario where it may be of interest to the user to overrule the reprogramming and not to show more interesting display 40, might be where it is important to the user to prevent the mobile phone 10 serving as a distraction, such as when mounted in a holder on the dashboard of a car, for example.

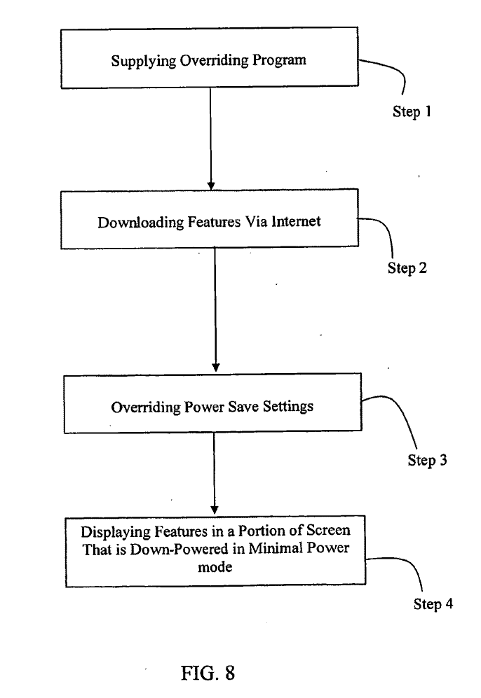

With further reference to FIG. 8 a method of the essential steps of the invention is presented showing how a more interesting display 40 that requires more than minimal power may be downloaded over the Internet 12 for displaying on a screen 16 of a mobile phone 10, instead of the dormant display 16′ wherein the screen 16 is merely darkened or configured to show a clock 42. The method comprises the steps of: supplying an override program—(Step 1); downloading features, such as advertising slogans, coupons, graphics, animation, etc. via the Internet 12 (Step 2); overriding the power saving display settings programmed into the mobile phone 10 by the manufacturer/supplier of the mobile phone 10 (step 3) and displaying the features on at least a portion of the screen 16 in a manner that requires more energy than the dormant mode (step 4).

There are a number of ways in which the mobile phone 10 may be reprogrammed. In one such way, and in accordance with one embodiment of the invention, a program is downloaded to the mobile phone 10 from a website 13 over the Internet 12. To prevent adversely affecting the services accessed by the user, preferably the downloading of the program occurs whilst the mobile phone is dormant, i.e. is not being actively used by the user, nor is it being moved and thus put into an active mode by a motion sensor, or the like.

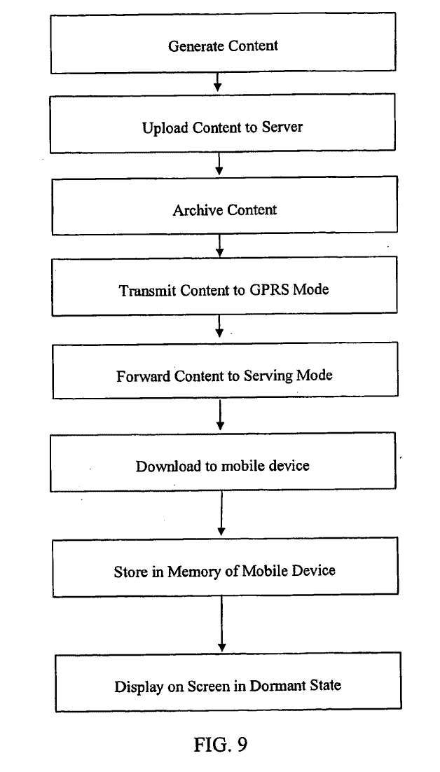

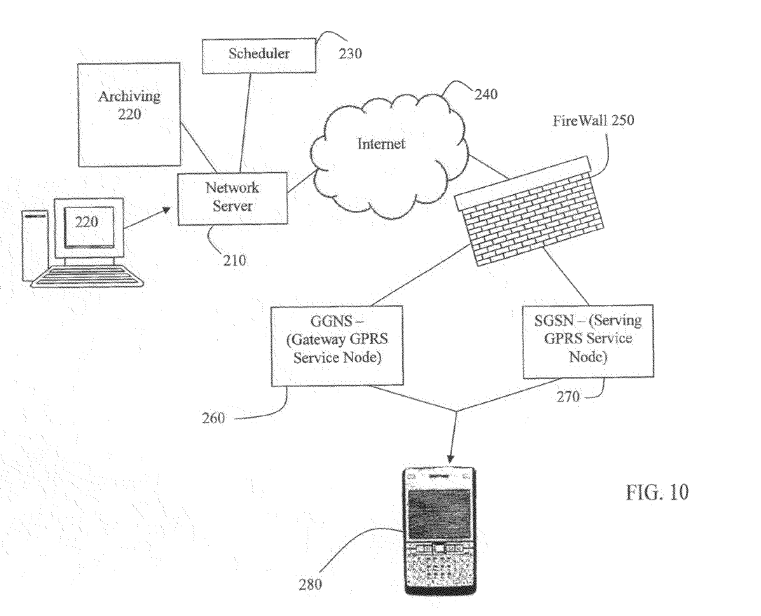

Referring to the block diagram of FIG. 9 and the flowchart of FIG. 10, the system components and method by which an advertisement may be downloaded to a mobile phone or similar is schematically shown.

In a first step, content such as an image file is generated (step I) on a computer 200, typically by an advertising agency or the like. The content is then uploaded (Step II) onto a network server 210 which may be hosted in the cellular phone operator's facility or elsewhere on the Internet in an accessible hosting facility. Any authorized content generator will be able to upload their content to the server 210. Content is archived (step III) in an archive 220 of the server 210. A scheduler 230 enables scheduling of when then content is to be downloaded, enabling effective advertising campaigns to be created. The content is transmitted (step IV) via an Internet link 240 through the operator's firewall 250 to the Gateway GPRS Service Node 260, from where it is forwarded (step V) to the Serving GPRS Service Node 270 and downloaded (step VI) to the mobile device 280, preferably using stealth technology to minimally disturb the user of the mobile device 280. The content is stored (step VIII) in the memory 290 of the mobile device 280, erasing previously downloaded content, where it is displayed (Step IX) on the screen of the mobile device 280 whilst in a dormant state, i.e. whilst not in active use.

The downloading of the program may occur by GPRS (General Packet Radio Service), which is a Mobile Data Service available to users of GSM and IS-136 mobile phones; it being appreciated that GPRS can be utilized not only for services such as WAP access, SMS and MMS, but also for Internet communication services such as email and web access. GPRS provides moderate speed data transfer, by using unused TDMA channels in for example the GSM system. GPRS is a packet-switched technology which enables multiple users to share the same transmission channel, only transmitting when they have data to send. In consequence, the total available bandwidth can be immediately dedicated to those users who are actually sending at any given moment, providing higher utilization where users only send or receive data intermittently.

Instead of GPRS, other technologies, such as UMTS (Universal Mobile Telecommunications System)—also known as 3GSM—may be used for reprogramming the mobile phone and/or for downloading images to the phone for displaying on the screen whilst the phone is dormant. Other mobile phone data transfer standards could be substituted. To avoid disturbing the user, a stealth technology is preferred wherein the data transfer occurs when the user is not interacting with the mobile phone. Alternatively, the reprogramming is achieved by coupling the mobile phone to a computer terminal and overwriting settings of the mobile phone. In yet other embodiments, reprogramming is achieved by removing a component of the mobile phone such as a SIM card, for example, and reprogramming the component and replacing, or switching the original SIM card with a preprogrammed SIM card that supports active displaying an image which requires more memory than the display of the dormant state considered by supplier/manufacturer of the mobile phone. Thus in general, the software required on a messaging device to implement this system might be built into the device or retrofitted to the device.

As described above with reference to FIGS. 9 and 10, the content may be stored in an archive 220 on the server 210 and transmitted to the Gateway GPRS Service Node 260, from where it is forwarded (step V) to the Serving GPRS Service Node 270 and downloaded (step VI) to the mobile device 280 in accordance with scheduling decisions taken by a scheduler 230 on the server 210. In such a configuration, the downloading is stealthy and is pushed to the mobile device 280. Alternatively however, the mobile device 280 can be configured to pull content from the server 210 at fixed intervals.

Persons of the art will appreciate that various programming languages and steps may be used to reconfigure the dormant display as supplied with the mobile device or to over-ride the dormant display, converting the standby display into the dormant display by keeping it on view indefinitely, until replaced with fresh content.

Although described hereinabove with reference primarily to mobile phones, the invention is applicable to other mobile devices, such as laptop computers, palmtop computers, MP 3 players, MP 4 players, iPODs, tablets and personal organizers, for example. Significantly, the content for inclusion in the enhanced visual display may be updated remotely without the user's control or intervention.

Furthermore, persons of the art will appreciate that there are a number of essentially equivalent ways to download content to the mobile device from the content provider.

Thus the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

We claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A method of displaying a select image on a mobile device comprising a power supply, a memory, a processor and a screen preconfigured by a supplier of the mobile device to assume a dormant mode in which the screen draws minimal power from the battery, with at most a basic visual display in only a section of the screen; the method comprising the steps of: (i) reprogramming the mobile device to display an enhanced display instead of the basic display by overriding the dormant screen mode; (ii) downloading a select image to a memory of the mobile device from an Internet source; (iii) displaying the enhanced display comprising the select image on the screen instead of the basic visual display of the minimal power dormant mode, wherein the displaying of the enhanced visual display requires more power than the minimal power required for the dormant mode.

37. The method of claim 36, wherein the mobile device is Internet enabled.

38. The method of claim 36, wherein the step (i) of reprogramming comprises downloading a program to the mobile device from a website over the Internet uses an appropriate protocol.

39. The method of claim 38, the protocol being selected from the list comprising GPRS and UMTS.

40. The method of claim 36, wherein the step of downloading occurs when the mobile phone is dormant.

41. The method of claim 36, wherein the select image is displayed intermittently whilst the mobile device is otherwise dormant.

42. The method of claim 36, wherein the step (i) of reprogramming comprises at least one of the following restrictions:
(a) coupling the mobile device to a computer terminal and overwriting settings of the mobile device;
(b) exchanging a SIM card of the mobile device;
(c) being over-rideable by the user to conserve power drawn from the power supply;
(d) downloading a program to the mobile device from a website over the Internet uses an appropriate protocol.

43. The method of claim 36, wherein the select image is displayed in a manner selected from the group comprising:
(p) continuously whilst the mobile device is otherwise dormant;
(q) intermittently whilst the mobile device is otherwise dormant, and
(r) being backlit by backlighting the screen despite the mobile device being otherwise dormant;

44. The method of claim 36 wherein the select image comprises at least one of the group comprising: a clock and a static image downloaded to the screen and displayed on a portion of the screen not where said clock is displayed; a multicolored image; a plurality of static images displayed sequentially; an animation; a coupon the the user can interact with thereby activating the mobile device and leaving the dormant state.

45. The method of claim 36, wherein the mobile device comprises a telephony terminal, the image comprises an advertisement and revenue provided to a telephone service provider by an image provider subsidizes billing of telephony service provider.

46. The method of claim 36, wherein an interaction with a key of the keypad will activate the mobile device and cause screen to show a display other than the more than minimal power drawing display of the invention.

47. The method of claim 36, wherein the mobile device is selected from the list comprising a mobile phone; a laptop computer, a palmtop computer, an i-POD, MP 3 player, MP 4 player, tablet and a personal organizer.

48. A mobile device comprising a battery, a processor, a memory and a screen, the interne enabled mobile device having a dormant state for conserving power drawn from the battery such that when in the dormant state a basic visual display requiring minimal power is displayed on the screen, wherein said mobile device is reprogrammed to display features on the screen in the dormant state by drawing more power than the minimal power required by the basic visual display of the dormant state as programmed by the manufacturer.

49. The mobile device of claim 48 being either Internet enabled with the reprogramming being via the Internet, or being coupleable to a computer, the reprogramming being via the computer.

50. The mobile device of claim 38, wherein the features displayable on the screen are downloadable to the mobile device by an Internet connection.

51. The mobile device of claim 48, wherein the features are displayable by a stealth technology when the mobile device is not in active use.

52. A mobile device comprising a battery, a processor, a memory and a screen, the mobile device comprising a reprogrammed dormant state such that when dormant, the screen draws more power from the battery than the minimal power supplied to the screen for displaying the dormant display in the configuration supplied by the supplier.

53. The mobile device of claim 52, such that when dormant, the screen displays an image despite the mobile phone not being interacted with.

54. The mobile device of claim 53, such that when dormant, said image is selected from the group comprising multicolored images, graphic images, text images comprising letters, and animations.

55. The mobile device of claim 53, such that when dormant, the image allows an interaction, wherein the interaction activates the mobile device, bringing it into an active state.
